(19) United States
(12) Patent Application Publication
(10) Pub. No.: US 2026/0022537 A1
(43) Pub. Date: Jan. 22, 2026

(54) HYDRAULIC FILTER SECURING DEVICE, HYDRAULIC TANK ASSEMBLY, AND WORK VEHICLE

(71) Applicant: KUBOTA CORPORATION, Osaka-shi (JP)

(72) Inventors: Christian Hayes DESBIEN, Lindsborg, KS (US); Yuji FUKUDA, Salina, KS (US)

(73) Assignee: KUBOTA CORPORATION, Osaka-shi (JP)

(21) Appl. No.: 18/776,165

(22) Filed: Jul. 17, 2024

(51) Int. Cl. E02F 9/22; E02F 9/08; F15B 21/041

(52) U.S. Cl. CPC E02F 9/2264; E02F 9/0883; F01M 11/0004; F01M 2011/0029

(57) ABSTRACT

A hydraulic filter securing device includes an oil pipe including a first thread to engage with a second thread of a hexagonal section of a return filter. An external flange is provided on an outer side surface of the oil pipe between the first end and the second end along a central axis. The external flange has a slot elongated in a circumferential direction with respect to the central axis. The retention bolt includes a shaft and a head. At least part of the shaft has a third thread, and the shaft passes through the slot. The head is provided at a position along the slot such that either the head or the shaft contacts with the hexagonal section when the second thread engages with the first thread. The head is restrained from sliding on the external flange along the slot.

### BACKGROUND OF THE INVENTION

### Field of the Invention

The present application relates to a hydraulic filter securing device, a hydraulic tank assembly, and a work vehicle.

### Discussion of the Background

There are various hydraulic filter securing devices and hydraulic tank assemblies for work vehicles. Japanese Examined Utility Model Application Publication No. H07-000728 shows a hydraulic filter securing device including a base, a nut screwed into the base.

Japanese Unexamined Patent Application Publication No. H06-191297 and Japanese Patent No. 6259359 show a hydraulic tank having an opening and a tank cover detachable from the hydraulic tank.

### SUMMARY OF THE INVENTION

According to one aspect of the present invention, a hydraulic filter securing device includes a cover plate, an oil pipe, an external flange, a retention bolt, and a nut. The cover plate is to be attached to a container of a hydraulic tank. The cover plate has a first opening. The oil pipe is provided through the first opening. The oil pipe has a first end attached to the cover plate and a second end opposite to the first end along a central axis of the oil pipe. The oil pipe includes a first thread at the second end to engage with a second thread of a hexagonal section of a return filter. The external flange is provided on an outer side surface of the oil pipe between the first end and the second end along the central axis. The external flange has a slot elongated in a circumferential direction with respect to the central axis. The retention bolt includes a shaft and a head. At least part of the shaft has a third thread, and the shaft passes through the slot. The head is provided at a position along the slot such that either the head or the shaft contacts with the hexagonal section when the second thread engages with the first thread. The nut is screwed with the third thread to fasten the retention bolt to the external flange such that the head is restrained from sliding on the external flange along the slot.

According to another aspect of the present invention, a hydraulic filter securing device includes a cover plate, an oil pipe, an external flange, and a retention bar. The cover plate is to be attached to a container of a hydraulic tank. The cover plate has a first opening. The oil pipe is provided through the first opening. The oil pipe has a first end attached to the cover plate and a second end opposite to the first end along a central axis of the oil pipe. The oil pipe includes a first thread at the second end to engage with a second thread of a hexagonal section of a return filter. The external flange is provided on an outer side surface of the oil pipe between the first end and the second end along the central axis such that the external flange is apart from the container. The external flange has a bar insertion hole. The retention bar includes a shaft and a head. The head is provided between the external flange and the first end along the central axis. The shaft passes through the bar insertion hole to contact with the hexagonal section when the second thread is threaded into the first thread.

According to further aspect of the present disclosure, a hydraulic tank assembly includes the hydraulic filter securing device according to the one aspect or the other aspect, the return filter, the hydraulic tank, and a fastener. The hydraulic filter securing device further includes a seal ring provided on the cover plate such that the seal ring surrounds the first opening. The return filter is connected to the hydraulic filter securing device. The hydraulic tank includes the container having a second opening covered by the cover plate. The fastener connects the cover plate to the container. The seal ring is provided between the cover plate and the container such that the second opening is surrounded by the seal ring.

According to further aspect of the present disclosure, a work vehicle includes the hydraulic filter securing device according to the one aspect or the other aspect.

According to further aspect of the present disclosure, a work vehicle includes the hydraulic tank assembly according to the further aspect.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a side view of a work vehicle according to an embodiment.

FIG. 2 is a plan view of the work vehicle.

FIG. 3 is a perspective view of the hydraulic tank assembly.

FIG. 4 is a top view of the hydraulic tank assembly.

FIG. 5 is a right-side view of the hydraulic tank assembly.

FIG. 6 is a left-side view of the hydraulic tank assembly.

FIG. 7 is an enlarged perspective view of the hydraulic filter securing device.

FIG. 8 is an exploded view of the hydraulic filter securing device.

FIG. 9 is an enlarged exploded view of the oil pipe.

FIG. 10 is an enlarged view of a connection of the first pipe portion and the second pipe portion.

FIG. 11 is an enlarged view of a connection of the first pipe portion and the third pipe portion.

FIG. 12 is a cross-sectional view of the hydraulic filter securing device taken along line X-X of FIGS. 5 and 6.

FIG. 13 is a cross-sectional view of the hydraulic tank assembly taken along line XIII-XIII of FIGS. 4 and 5.

FIG. 14 is a first modification of an enlarged perspective view of a part of the hydraulic filter securing device.

FIG. 15 is a cross-sectional view of the first modification similarly to the FIG. 10.

FIG. 16 is a second modification of an enlarged perspective view of a part of the hydraulic filter securing device.

FIG. 17 is a third modification of an enlarged perspective view of a part of the hydraulic filter securing device.

### DESCRIPTION OF THE EMBODIMENTS

Embodiments will now be described below with reference to the drawings. Same reference signs denote corresponding or identical configurations in the drawings.

### Embodiment

### Overall Configuration

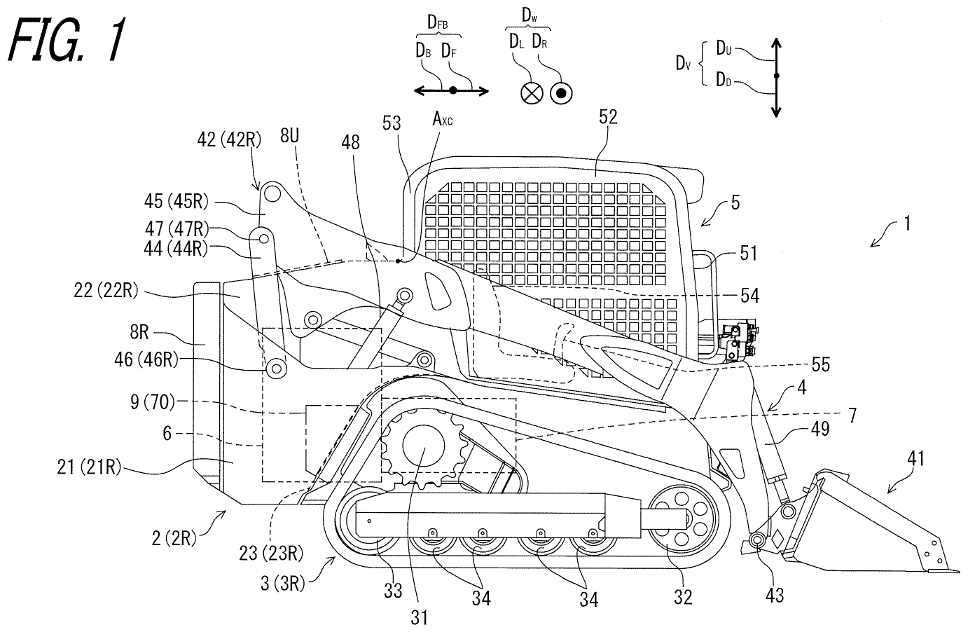

FIG. 1 is a side view of a work vehicle 1 according to the embodiment. Examples of the work vehicle 1 include a compact track loader. The work vehicle 1 includes a vehicle body 2, a pair of travel devices 3, and a work device 4. The vehicle body 2 supports the travel devices 3 and the work device 4. In the illustrated embodiment, the travel devices 3 are crawler-type travel devices. Thus, each of the pair of travel devices 3 includes a drive wheel 31 that are driven by the hydraulic motor devices 30, driven wheels 32 and 33, and track rollers 34. However, each of the pair of travel devices 3 is not limited to a crawler type travel device. Each of the pair of travel devices 3 may be, for example, a front wheel/rear wheel travel device or a travel device including a front wheel and a rear crawler. In such case, the work vehicle 1 could include a skid steer loader. Accordingly, examples of the work vehicle 1 can include loaders such as a compact track loader and a skid steer loader. The work device 4 includes work equipment (bucket) 41 at a distal end of the work device 4. A proximal end of the work device 4 is attached to the rear of the vehicle body 2. The work device 4 includes a pair of arm mechanisms 42 to rotatably support the bucket 41 via a bucket pivot shaft 43. Each of the pair of arm mechanisms 42 includes a link 44 and an arm 45.

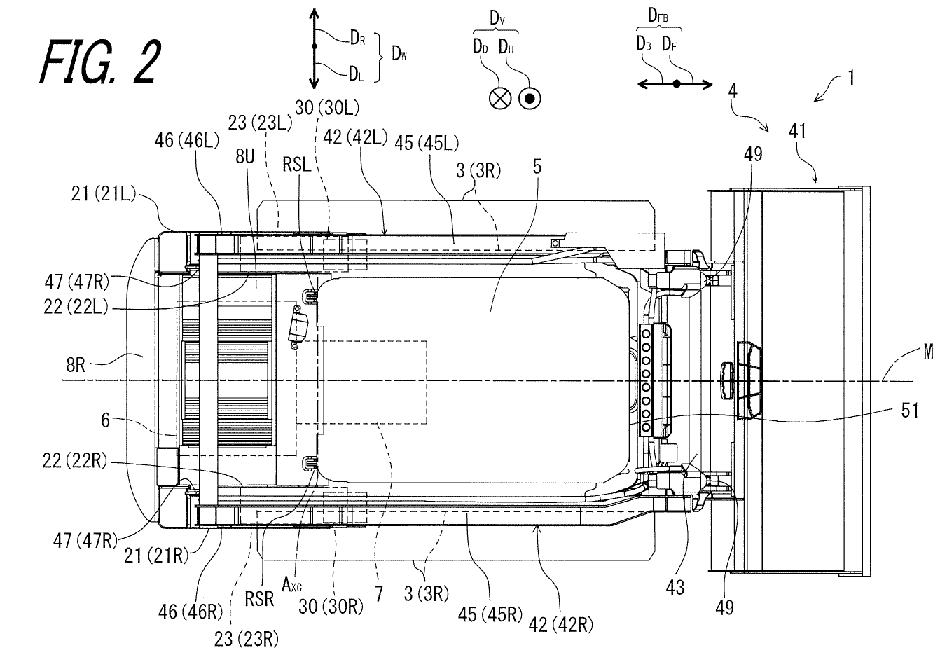

The link 44 is rotatable relative to the vehicle body 2 about a fulcrum shaft 46. The arm 45 is rotatable relative to the link 44 about a joint shaft 47. The work device 4 further includes a plurality of arm cylinders 48 and at least one equipment cylinder 49. Each of the plurality of arm cylinders 48 is rotatably connected to the vehicle body 2 and the arm 45, and moves the link 44, the arm 45, and the like to raise and lower the bucket 41. The at least one implement cylinder 49 is configured to tilt the bucket 41. The vehicle body 2 includes a cabin 5. The cabin 5 includes a front window 51 that can be opened and closed and is defined by a cab frame 53. The front window 51 may be omitted. The work vehicle 1 includes an operator's seat 54 and an operation lever 55 in a cabin 5. The cab frame 53 is rotatable about rotational shafts RSL and RSR on the vehicle body 2, as shown in FIG. 2. FIGS. 1 and 2 illustrate a common pivot Axc defined by the pivot axes RSL and RSR. That is, the cab frame 53 is attached to the vehicle body 2 so as to be rotatable about the common pivot Axc.

In the embodiment according to the present application, the front-rear direction D_{FB} (front direction D_{F}/rear direction D_{B}) means a front-rear direction (front direction/rear direction) as viewed from an operator seated in the operator's seat 54 of the cabin 5. The left direction D_{L}, the right direction D_{R}, and the width direction D_{W} respectively mean a left direction, a right direction, and a left and right direction as viewed from the operator. The upward direction D_{U}, the downward direction D_{D}, and the vertical direction D_{V} mean an upward direction, a downward direction, and a vertical direction as viewed from the operator. The front-rear/left-right (width)/up-down (vertical) directions of the work vehicle 1 respectively coincide with the front-rear/left-right (width)/up-down (vertical) directions viewed from the operator.

FIG. 1 shows the right side of the work vehicle 1. As shown in FIG. 2, the vehicle body 2 is substantially plane-symmetrical with respect to the vehicle body center plane M, and includes a first side body 2L that is a left side body and a second side body 2R that is a right side body. Among the pair of travel devices 3, a travel device 3 provided on the first side body 2L is shown as a first travel device 3L, and a travel device 3 provided on the second side body 2R is shown as a second travel device 3R. Among the pair of arm mechanisms 42, an arm mechanism 42 provided on the left side with respect to the vehicle body center plane M is shown as a first arm mechanism 42L, and an arm mechanism 42 provided on the right side with respect to the vehicle body center plane M is shown as a second arm mechanism 42R. The link 44 provided on the right side with respect to the vehicle body center plane M is shown as a second link 44R. The arm 45 provided on the left side with respect to the vehicle body center plane M is shown as a first arm 45L, and the arm 45 provided on the right side with respect to the vehicle body center plane M is shown as a second arm 45R. The fulcrum shaft 46 provided on the left side with respect to the vehicle body center plane M is shown as a first fulcrum shaft 46L, and the fulcrum shaft 46 provided on the right side with respect to the vehicle body center plane M is shown as a second fulcrum shaft 46R. The joint shaft 47 provided on the left side with respect to the vehicle body center plane M is shown as a first joint shaft 47L, and the joint shaft 47 provided on the right side with respect to the vehicle body center plane M is shown as a second joint shaft 47R. Among the hydraulic motor devices 30, a hydraulic motor device 30 provided on the left side with respect to the vehicle body center plane M is shown as a first hydraulic motor device 30L, and a hydraulic motor device 30 provided on the right side with respect to the vehicle body center plane M is shown as a second hydraulic motor device 30R.

Referring to FIGS. 1 and 2, the vehicle body 2 includes outer frames 21 and inner frames 22 provided between the outer frames 21. The vehicle body 2 further includes mudguard frames 23 that connect outer frames 21 and inner frames 22, respectively. More specifically, the first side body 2L includes a first outer frame 21L and a first inner frame 22L. The second side body 2R includes a second outer frame 21R and a second inner frame 22R. The first side body 2L includes a first mudguard frame 23L connecting the first outer frame 21L and the first inner frame 22L. The second side body 2R includes a second mudguard frame 23R connecting the second outer frame 21R and the second inner frame 22R. The arm 45 is supported by an outer frame 21 and an inner frame 22 via the fulcrum shaft 46. More specifically, the first arm 45L is supported by the first outer frame 21L and the first inner frame 22L via the first fulcrum shaft 46L. The second arm 45R is supported by the second outer frame 21R and the second inner frame 22R via the second fulcrum shaft 46R. The mudguard frames 23 partially overlap with the travel devices 3, respectively, as viewed in the vertical direction D_{V}. More specifically, the first mudguard frame 23L partially overlaps with the first travel device 3L as viewed in the vertical direction D_{V}. The second mudguard frame 23R partially overlaps with the second travel device 3R as viewed in the vertical direction D_{V}.

Referring to FIGS. 1 and 2, the work vehicle 1 further includes an engine 6 provided in a rear portion of the vehicle body 2, and at least one hydraulic pump 7. The engine 6 drives the at least one hydraulic pump 7. The at least one hydraulic pump 7 is configured to discharge hydraulic fluid to drive the hydraulic motor devices 30 etc. to drive the drive wheels 31. The at least one hydraulic pump 7 is configured to discharge hydraulic fluid to drive hydraulic actuators connected to the work device 4 (the plurality of arm cylinders 48, the at least one implement cylinder 49, and the like). The engine 6 is provided between the pair of arm mechanisms 42 in the width direction D_{W} of the work vehicle 1. The work vehicle 1 further includes an upper cover 8U to cover the engine 6. The work vehicle 1 further includes a bonnet cover 8R provided at the rear end of the vehicle body 2. The bonnet cover 8R is openable and closable to enable a maintenance person to perform maintenance work of the engine 6 and the like.

As shown in FIGS. 1 and 3-6, the work vehicle 1 further includes a hydraulic tank assembly 9. The hydraulic tank assembly 9 includes a hydraulic tank 70, a return filter 10, a suction filter 15, joints 24-25, and a hydraulic filter securing device 80. The hydraulic tank 70 is configured to store hydraulic fluid (hydraulic oil) to be used by the at least one hydraulic pump 7, the hydraulic motor devices 30, and the hydraulic actuators. The hydraulic tank 70 is provided on the second mudguard frame 23R via the joints 24 and 25. However, the hydraulic tank 70 may be provided on the first mudguard frame 23L via the joints 24 and 25. The return filter 10 is provided in the hydraulic tank 70. The return filter 10 is connected to the hydraulic motor devices 30 and the hydraulic actuators via a return pipe 17. The hydraulic fluid used in hydraulic motor devices 30 and the hydraulic actuators is returned to the hydraulic tank 70 via the return pipe 17 and the return filter 10. The return filter 10 is attached to the hydraulic tank 70 via the hydraulic filter securing device 80. The return filter 10 is connected to the hydraulic filter securing device 80. The suction filter 15 is provided in the hydraulic tank 70. The hydraulic tank assembly 9 further includes a delivery pipe 16. The suction filter 15 is connected to the at least one hydraulic pump 7 via the delivery pipe 16. The hydraulic fluid stored in the hydraulic tank 70 is sent to the at least one hydraulic pump 7 via the suction filter 15 and the delivery pipe 16.

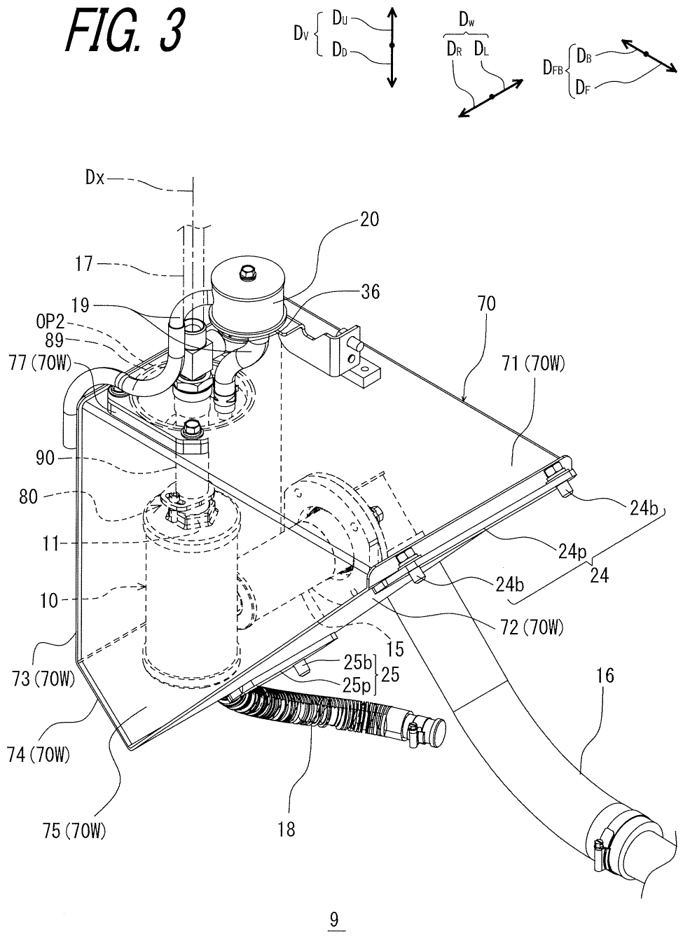

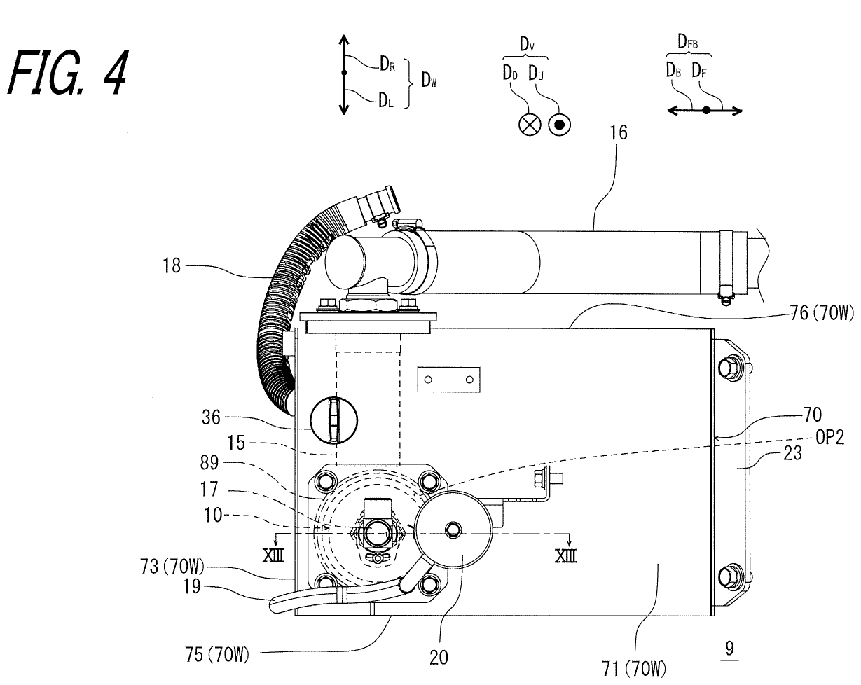

The hydraulic tank 70 has a container 70W configured to store a hydraulic oil and having a shape of a truncated triangular prism in order to fit with a shape of the second mudguard frame 23R. More specifically, the container 70W includes a top wall 71, a front wall 72, a rear wall 73, a slanted bottom wall 74, a first side wall 75, and a second side wall 76. The second side wall 76 is opposite to the first side wall 75 in the width direction D_{W}. As shown in FIGS. 3 and 4, the top wall 71, the front wall 72, the rear wall 73, and the slanted bottom wall 74 each connect the first side wall 75 and the second side wall 76.

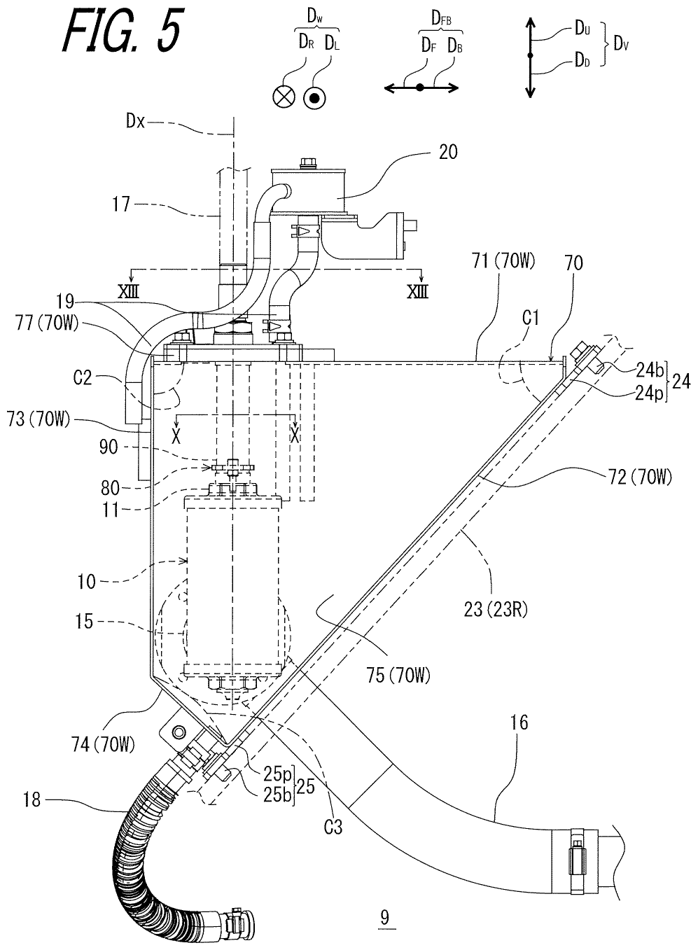

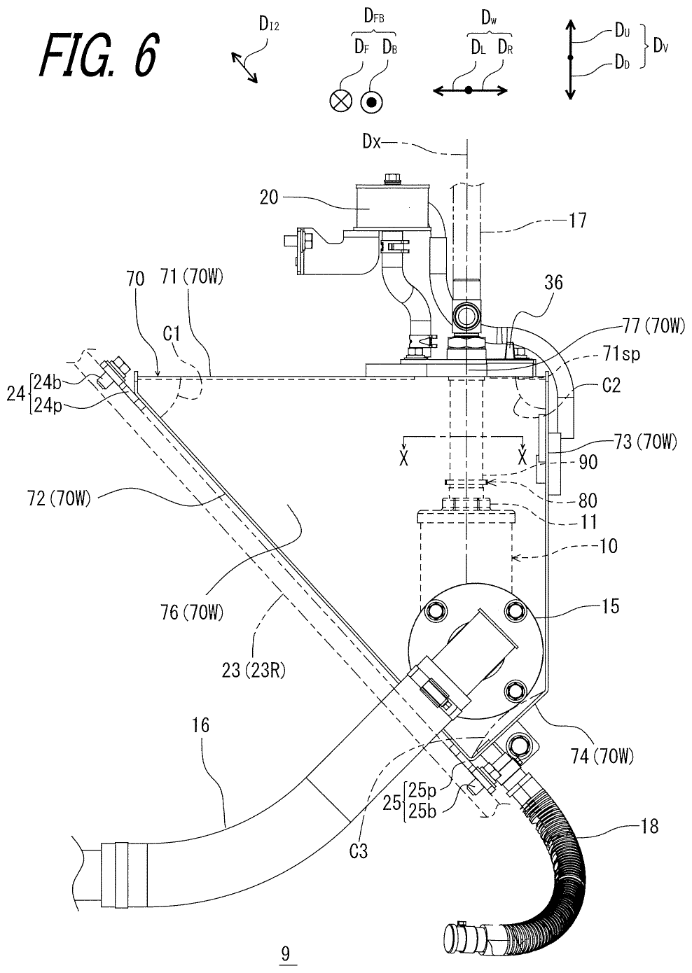

As shown in FIGS. 5 and 6, each of the first side wall 75 and the second side wall 76 has a shape of a truncated triangle. The truncated triangle has a first substantially untruncated corner C1, a second substantially untruncated corner C2, and a truncated corner C3. The top wall 71 is provided between the first substantially untruncated corner C1 and the second substantially untruncated corner C2. The front wall 72 is provided between the first substantially untruncated corner C1 and the truncated corner C3 and is supported by a mudguard (the second mudguard frame 23R) of the work vehicle 1. The rear wall 73 is provided between the second substantially untruncated corner C2 and the truncated corner C3. The slanted bottom wall 74 is provided at the truncated corner C3 to connect the rear wall and 73 the front wall 72. The container 70W further includes an upper protrusion 77 provided on the top wall 71. The upper protrusion 77 and the top wall 71 may be integrally shaped. Alternatively, the upper protrusion 77 may be bonded to the top wall 71.

The front wall 72 is attached to the second mudguard frame 23R via a first joint 24 and a second joint 25. The first joint 24 includes a first base plate 24p connected to a top of the front wall 72 to be placed on the second mudguard frame 23R and a first connection bolt 24b to connect the first base plate 24p and the second mudguard frame 23R. The second joint 25 includes a second base plate 25p connected to a bottom of the front wall 72 to be placed on the second mudguard frame 23R and a second connection bolt 25b to connect the second base plate 25p and the second mudguard frame 23R.

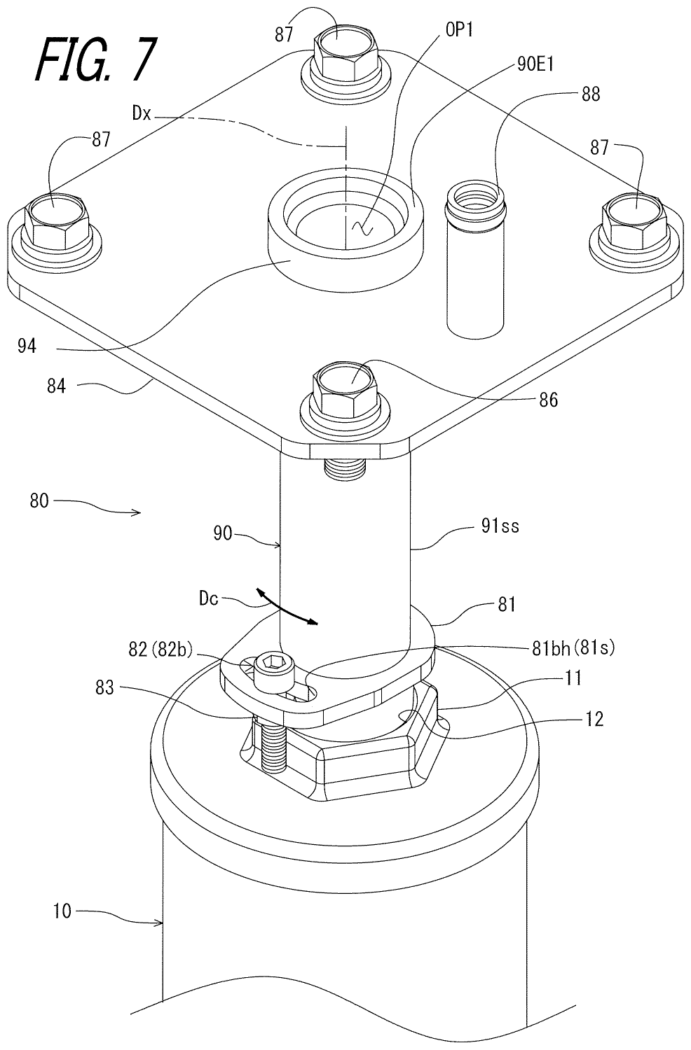

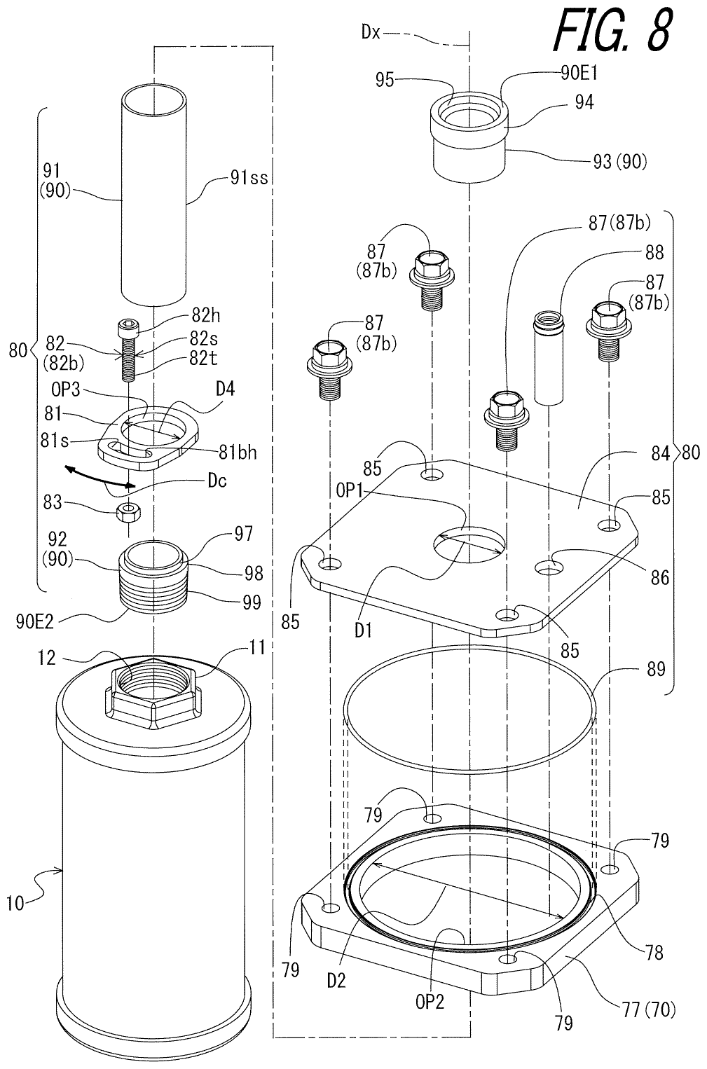

FIG. 7 is an enlarged perspective view of the hydraulic filter securing device 80. FIG. 8 is an exploded view of the hydraulic filter securing device 80. As shown in FIG. 7, the hydraulic filter securing device 80 includes an external flange 81, a retention bar 82, a nut 83, an oil pipe 90, and a cover plate 84. The cover plate 84 is configured to be attached to the container 70W of the hydraulic tank 70. The cover plate 84 has a first opening OP1. The oil pipe 90 is provided through the first opening OP1. As shown in FIGS. 3, 5, and 6, the oil pipe 90 extends in the vertical direction D_{V}.

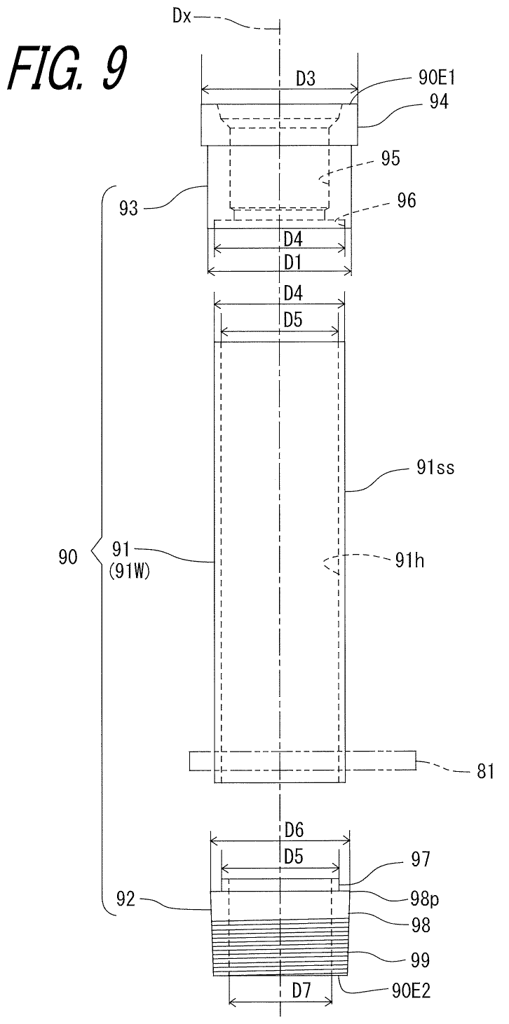

FIG. 9 is an enlarged exploded view of the oil pipe 90. As shown in FIGS. 7-9, the oil pipe 90 has a first end 90E1 attached to the cover plate 84 and a second end 90E2 opposite to the first end 90E1 along a central axis Dx of the oil pipe 90. The oil pipe 90 includes a first thread (a thread pipe portion 99) at the second end 90E2 to engage with a second thread 12 of a hexagonal section 11 of the return filter 10.

As shown in FIG. 9, the oil pipe 90 includes a first pipe portion 91, a second pipe portion 92, and a third pipe portion 93. The first pipe portion 91 includes a pipe wall 91W defining an outer side surface 91ss of the oil pipe 90 and an internal hole 91h surrounded by the pipe wall 91W. In FIG. 9, dashed lines represent lines of an object that are hidden from view. The second pipe portion 92 includes a threadless pipe portion 97, a protruded pipe portion 98, and the thread pipe portion 99. The threadless pipe portion 97 is inserted into the internal hole 91h. The protruded pipe portion 98 has a protrusion 98p and is provided between the thread pipe portion 99 and the threadless pipe portion 97 along the central axis Dx of the oil pipe 90. The thread pipe portion 99 has the first thread provided at the second end 90E2.

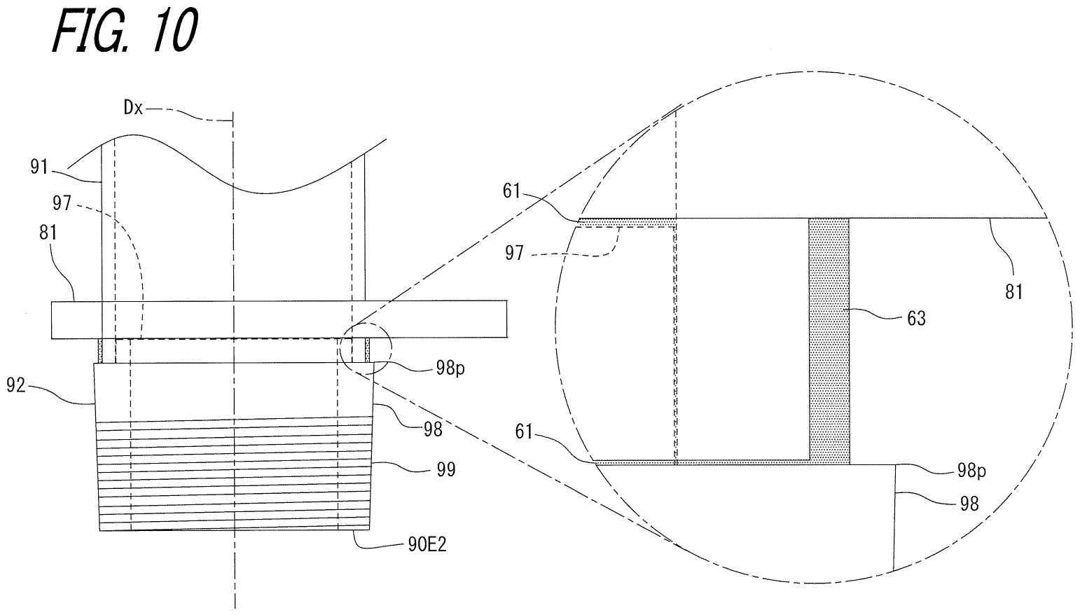

FIG. 10 is an enlarged view of a connection of the first pipe portion 91 and the second pipe portion 92. As seen in FIG. 10, the hydraulic filter securing device 80 further includes a first bonding material 61 bonding the first pipe portion 91 to the second pipe portion 92. The first bonding material 61 may include a brazing filler material or a furnace brazing filler material.

As shown in FIG. 9, the third pipe portion 93 includes a flange 94, a connection interface 95, and an insertion hole 96. The flange 94 is provided at the first end 90E1. A diameter D3 of the flange 94 is larger than a diameter D1 of the first opening OP1. The connection interface 95 is provided on an inner surface of the third pipe portion 93. The connection interface 95 is configured such that the return pipe 17 is connected to the third pipe portion 93 via the connection interface 95. The first pipe portion 91 is inserted into the insertion hole 96.

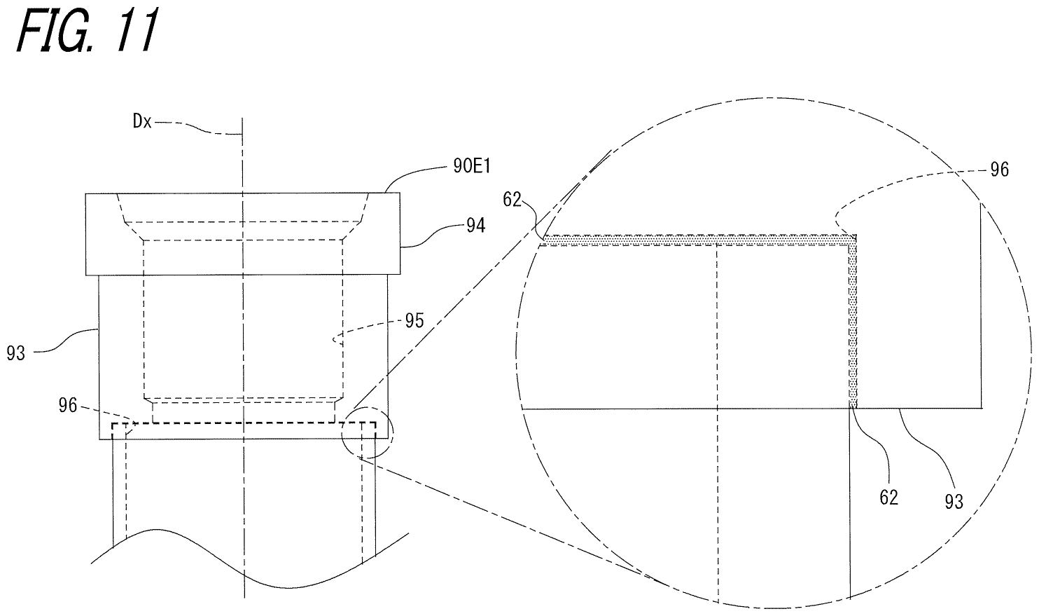

FIG. 11 is an enlarged view of a connection of the first pipe portion 91 and the third pipe portion 93. As seen in FIG. 11, the hydraulic filter securing device 80 further includes a second bonding material 62 bonding the first pipe portion 91 to the third pipe portion 93. The second bonding material 62 may include a brazing filler material or a furnace brazing filler material.

As shown in FIGS. 7-9, the external flange 81 is provided on the outer side surface 91ss of the oil pipe 90 between the first end 90E1 and the second end 90E2 along the central axis Dx such that the external flange 81 is apart from the container 70W. The external flange 81 has a bar insertion hole 81bh. The bar insertion hole 81bh is a slot 81s elongated in elongated in a circumferential direction Dc with respect to the central axis Dx.

The retention bar 82 includes a head 82h and a shaft 82s. In this embodiment, the retention bar 82 is a retention bolt 82b. At least part of the shaft 82s has a third thread 82t. The shaft 82s passes through the slot 81s. The shaft 82s passes through the bar insertion hole 81bh such that the shaft 82s is contactable with the hexagonal section 11 when the second thread 12 is threaded into the first thread (the thread pipe portion 99).

The head 82h is provided between the external flange 81 and the first end 90E1 along the central axis Dx. The head 82h is provided on the external flange 81 at a position along the slot 81s such that the shaft 82s is contactable with the hexagonal section 11 when the second thread 12 engages with the first thread (the thread pipe portion 99).

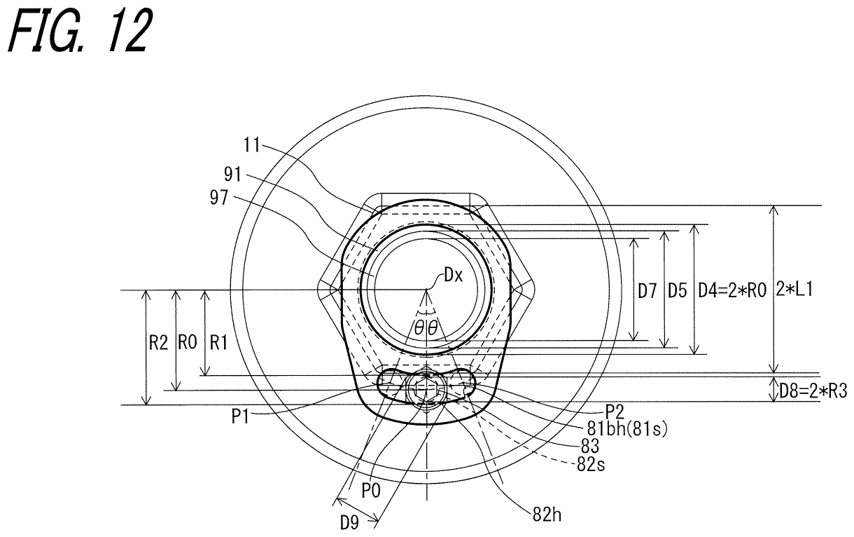

More specifically, as shown in FIG. 12, the retention bolt 82b is swingable between a left end P1 and a right end P2 along the slot 81s. A middle position P0 is defined at the middle of the left end P1 and the right end P2. An angle θ is defined by a line Ax-P0 and a line Ax-P1. The angle defined by a line Ax-P0 and a line Ax-P2 is the same as the angle θ. When a radius of an inner arc of the slot 81s is defined as R1 and a radius of an outer arc of the slot 81s is defined as R2, a radius R0 of a middle arc of the slot 81s is equal to (R1+R2)/2. When a distance of two opposing sides of the hexagonal section 11 is defined as 2*L1, the radius R1 is larger than L1 in order to allow the retention bolt 82b to be inserted into the slot 81s.

When a diameter of the shaft 82s is defined as D8=2*R3, (R2−D8) is larger than L1 in order to allow the retention bolt 82b to be inserted into the slot 81s. Furthermore, (R0−R3) is larger than L0/cos θ in order to allow the retention bolt 82b to be inserted into the slot 81s at the left end P1 or the right end P2. In addition, in order to make the shaft 82s contactable with the hexagonal section 11 when the second thread 12 engages with the first thread (the thread pipe portion 99), (R2−D8) is smaller than L1/cos 30°=2*L1/\sqrt{3} in order to allow the retention bolt 82b to be inserted into the slot 81s.

The nut 83 is screwed with the third thread 82t to fasten the retention bolt 82b to the external flange such that the head 82h is restrained from sliding on the external flange 81 along the slot 81s. When a length of a diagonal line of a hexagonal shape of the nut 83 is defined as D9, (R2-D9) is larger than L1 in order to allow the nut 83 to be screwed with the third thread 82t.

The external flange 81 has a through-hole TH through which the oil pipe 90 passes. A diameter of the through-hole TH is substantially equal to the diameter D4 of the outer side surface 91ss of the oil pipe 90. As shown in FIG. 12, the external flange 81 has a first side S1 and a second side S2 opposite to the first side S1 in a first side direction SD1 perpendicular to the central axis Dx of the oil pipe 90. Each of the first side S1 and the second side S2 has a substantially linear shape. The external flange 81 has a third side S3 and a fourth side S4 opposite to the third side S3 in a second side direction SD2 perpendicular to the first side direction SD1 and to the central axis Dx of the oil pipe 90. The slot 81s is provided between the through-hole TH and the third side S3 in the second side direction SD2. A distance L2 between the first side S1 and the second side S2 in the first side direction SD1 is substantially equal to a distance 2*L1 between two opposing sides of the hexagonal section 11. Accordingly, the external flange 81 and the hexagonal section 11 can be rotated around the oil pipe 90 by the same wrench.

As seen in FIGS. 9 and 10, the oil pipe 90 includes the protrusion 98p protruded from the outer side surface 91ss of the oil pipe 90 between the external flange 81 and the second end 90E2 along the central axis Dx. The diameter D4 of the through-hole DH is smaller than a diameter D6 of the protrusion 98p. Furthermore, the hydraulic filter securing device 80 further includes a brazing filler material 63 provided on the outer side surface 91ss of the oil pipe 90 between the external flange 81 and the protrusion 98p along the central axis Dx to connect the external flange 81 and the protrusion 98p. Accordingly, the protrusion 98p prevents the external flange 81 from being dropped from the oil pipe 90. The brazing filler material 63 may be equal to the first bonding material 61.

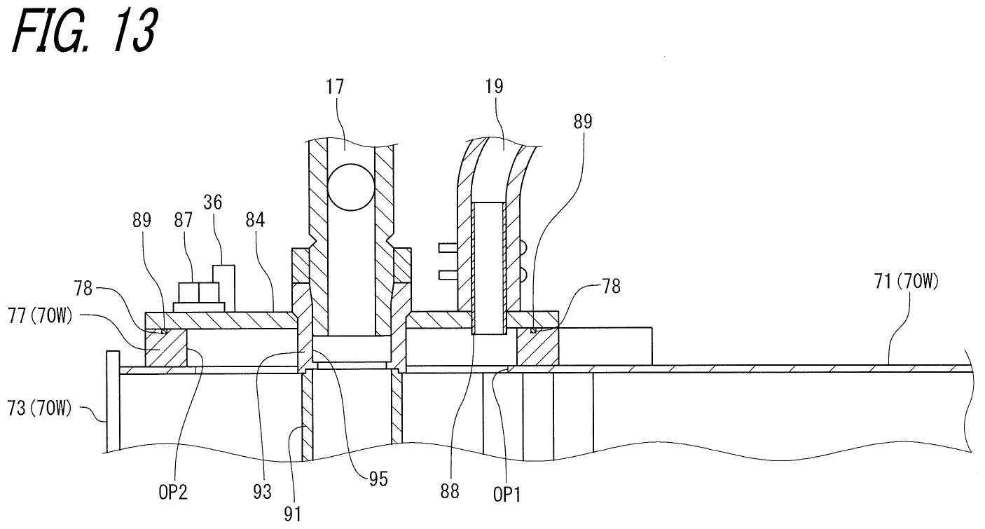

FIG. 13 is a cross-sectional view of the hydraulic tank assembly 9 taken along line XIII-XIII of FIGS. 4 and 5. As seen in FIGS. 5, 8, and 13, the container 70W has a second opening OP2 covered by the cover plate 84. More specifically, the top wall 71 has the second opening OP2. As shown in FIG. 4, the second opening OP2 is larger than the return filter 10. Thus, it is possible to put the return filter 10 out of the hydraulic tank 70 through the second opening OP2. The slanted bottom wall 74 is opposite to the second opening OP2 in the vertical direction D_{V} substantially perpendicular to the top wall 71. A bottom end of the return filter 10 is provided between the slanted bottom wall 74 and the front wall 72 in a lateral direction (the front-rear direction D_{FB}) perpendicular to the vertical direction D_{V}. Accordingly, the hydraulic fluid can be supplied from the return filter 10 near the bottom of the hydraulic tank 70. The suction filter 15 and the delivery pipe 16 are provided adjacent to the slanted bottom wall 74, thus the hydraulic fluid can be supplied from the vicinity of the bottom of the hydraulic tank 70. The hydraulic tank assembly 9 further includes a drain hose pipe 18 provided on the slanted bottom wall 74 in order to facilitate drainage of the hydraulic fluid in the hydraulic tank 70.

As shown in FIGS. 4, 8, and 13, the hydraulic filter securing device 80 further comprising a fastener 87 and a seal ring 89 provided on the cover plate 84 such that the seal ring 89 surrounds the first opening OP1. The container 70W (the upper protrusion 77) has a groove 78 configured such that the seal ring 89 is provided in the groove 78. As shown in FIGS. 4 and 13, the seal ring 89 is provided between the cover plate 84 and the container 70W such that the second opening OP2 is surrounded by the seal ring 89. The fastener 87 is configured to connect the cover plate 84 to the container 70W (the upper protrusion 77). For example, the fastener 87 includes bolts 87b. The cover plate 84 has through-holes 85 through which the bolts 87b are configured to pass, respectively. The upper protrusion 77 has female thread 79 into which threads of the bolts 87b are screwed, respectively.

As seen in FIGS. 3 and 8, the cover plate 84 has a vent hole 86 inside the seal ring 89. The hydraulic tank assembly 9 further includes a vent pipe 88, an air breather 20, and an outlet tube 19. The vent pipe 88 is connected to the vent hole 86. The air breather 20 is connected to the vent pipe 88. The outlet tube 19 is connected to the air breather 20. More specifically, the outlet tube 19 is connected to the vent pipe 88. The air breather 20 is connected to the vent pipe 88 via the outlet tube 19. As seen in FIGS. 3-6, the hydraulic tank assembly 9 further includes an oil supply port 71sp provided on the top wall 71, and a cap 36 to close the oil supply port 71sp. The hydraulic fluid is supplied to the hydraulic tank 70 via the oil supply port 71sp.

### Advantageous Effects of the Work Vehicle According to the Present Embodiment

The work vehicle 1 according to the embodiment has the following advantageous effects. The hydraulic filter securing device 80 includes the external flange 81 provided on the 91ss of the oil pipe 90 between the first end 90E1 and the second end 90E2 along the central axis Dx such that the external flange 81 is apart from the container 70W. The retention bolt 82b includes the shaft 82s and the head 82h. The head 82h is provided between the external flange 81 and the first end 90E1 along the central axis Dx. The shaft 82s passes through the bar insertion hole 81bh to contact with the hexagonal section 11 when the second thread 12 is threaded into the thread pipe portion 99. Accordingly, the hydraulic filter securing device 80 facilitates securely attaching the return filter 10 to the oil pipe 90. Furthermore, the hydraulic tank assembly 9 can save a space in another area of the work vehicle 1, because the return filter 10 is not taking up an external space in an engine room.

### Variations of the Embodiment

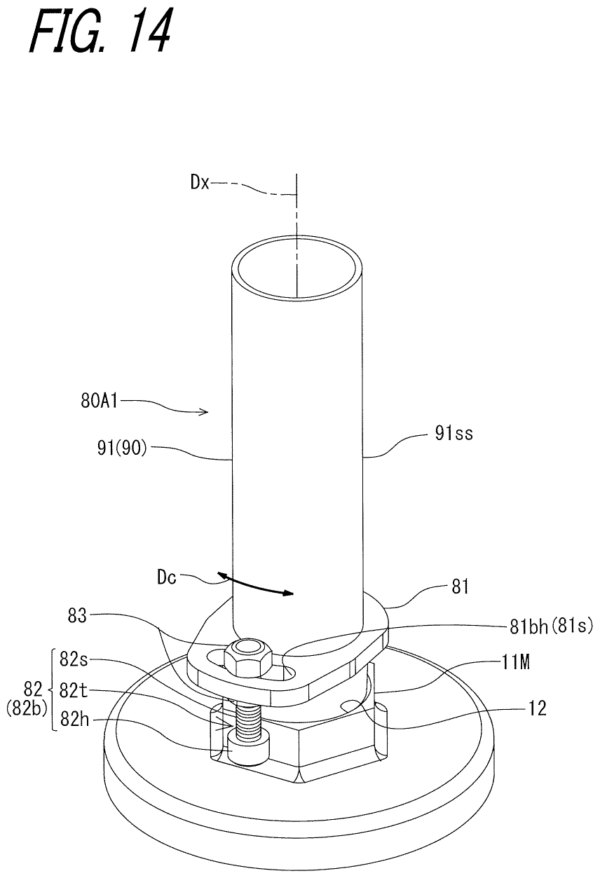

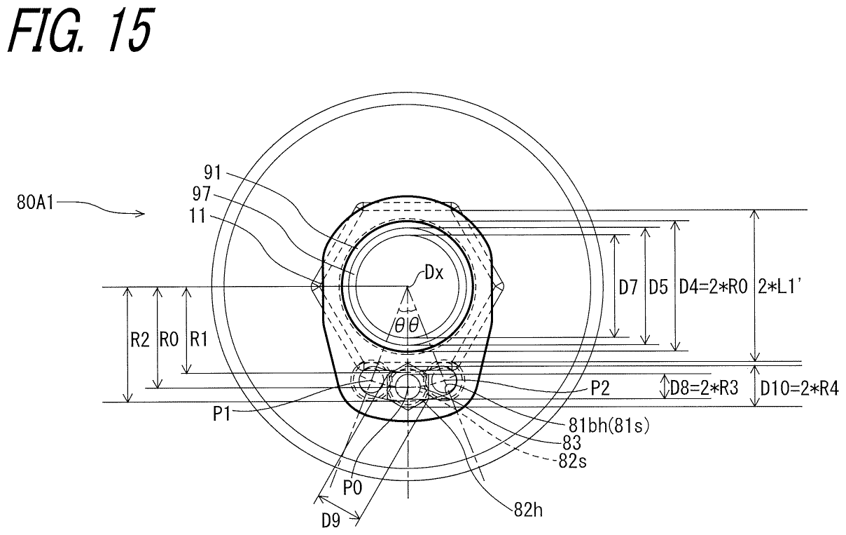

FIG. 14 is a first modification 80Al of an enlarged perspective view of a part of the hydraulic filter securing device. FIG. 15 is a cross-sectional view of the first modification 80A1 similarly to the FIG. 10. In the first modification 80A1, the retention bolt 82b and the nut 83 are positioned oppositely to those shown in FIG. 7. More specifically, the nut 83 is provided on the external flange 81, and the head 82h is provided between the external flange 81 and the first end 90E1 along the central axis Dx at a position along the slot 81s such that the head 82h is contactable with the hexagonal section 11 when the second thread 12 engages with the first thread (the thread pipe portion 99). Accordingly, the head 82h is provided on the external flange 81 at a position along the slot 81s such that either the head 82h or the shaft 82s is contactable contacts with the hexagonal section 11 when the second thread 12 engages with the first thread (the thread pipe portion 99).

In FIG. 14, when a distance of two opposing sides of the hexagonal section 11 is defined as 2*L1′, the radius R1 is larger than L1′ in order to allow the retention bolt 82b to be inserted into the slot 81s. When a diameter of the head 82h is defined as D10=2*R4, (R2−D10) is larger than L1′ in order to allow the retention bolt 82b to be inserted into the slot 81s. Furthermore, (R0−R4) is larger than L1/cos θ in order to allow the retention bolt 82b to be inserted into the slot 81s at the left end P1 or the right end P2. In addition, in order to make the head 82h contactable with the hexagonal section 11 when the second thread 12 engages with the first thread (the thread pipe portion 99), (R2-D10) is smaller than L1/cos 30°=2*L1/v3 in order to allow the retention bolt 82b to be inserted into the slot 81s.

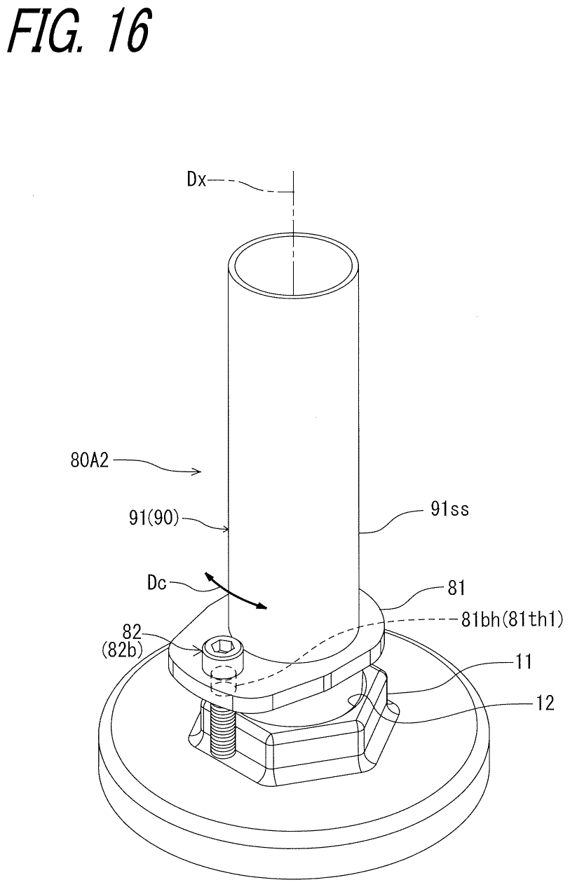

FIG. 16 is a second modification 80A2 of an enlarged perspective view of a part of the hydraulic filter securing device. In the second modification 80A2, the bar insertion hole 81bh is not a slot 81s but a circular hole 81th1. The circular hole 81th1 may have a thread or may not have a thread. In that case, the nut 83 can be omitted.

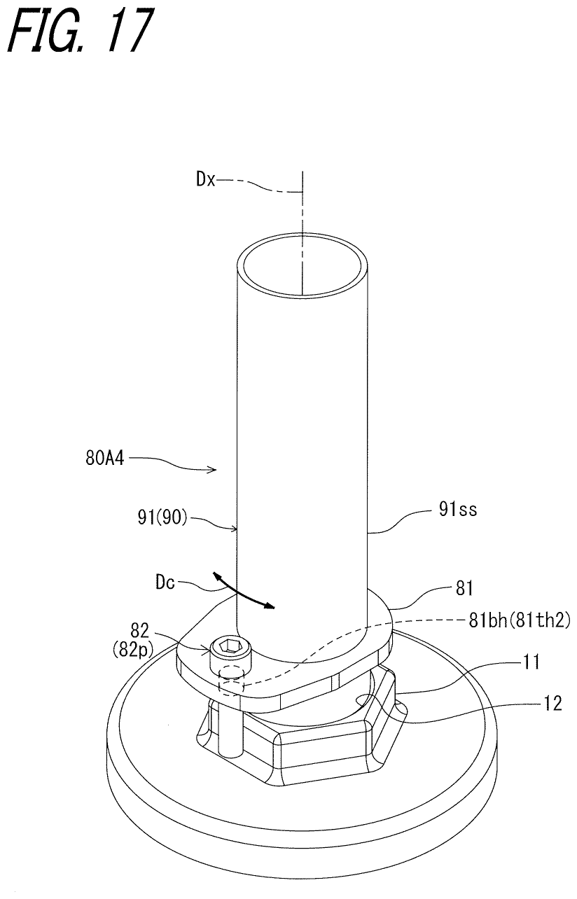

FIG. 17 is a third modification 80A3 of an enlarged perspective view of a part of the hydraulic filter securing device. In the third modification 80A3, the retention bar 82 may be a pin 82p. The pin 82p does not have thread.

The present application refers to words “include” and derivatives as nonrestrictive terms for description of provision of constituent elements, without exclusion of any other constituent element not referred to in the present application. The same applies to words “have”, “provided with”, and derivatives thereof.

Expressions “member”, “part”, “element”, “body”, and “structure” may have a plurality of meanings indicating a single portion and a plurality of portions.

Ordinal numbers “first”, “second”, and the like are terms for simple distinction among configurations, without having any other meaning (e.g. specific order). For example, provision of a “first element” does not indicate provision of a “second element”, and provision of the “second element” does not indicate provision of the “first element”.

Expressions “substantially”, “approximately”, “about”, and the like indicating degrees may each have a rational deviation not significantly changing a final result. All the numerical values referred to in the present application may be interpreted as including any one of the expressions “substantially”, “approximately”, “about”, and the like.

In view of the above disclosure, the present invention can obviously include various modifications and alterations. The present invention may thus be implemented in any manner different from those specifically disclosed in the present application without departing from the spirit of the preset invention.

What is claimed is:

1. A hydraulic filter securing device comprising:
a cover plate to be attached to a container of a hydraulic tank, the cover plate having a first opening;
an oil pipe provided through the first opening, the oil pipe having a first end attached to the cover plate and a second end opposite to the first end along a central axis of the oil pipe, the oil pipe including a first thread at the second end to engage with a second thread of a hexagonal section of a return filter;
an external flange provided on an outer side surface of the oil pipe between the first end and the second end along the central axis, the external flange having a slot elongated in a circumferential direction with respect to the central axis;
a retention bolt comprising:
a shaft at least part of which has a third thread, and which passes through the slot; and
a head provided at a position along the slot such that either the head or the shaft is contactable with the hexagonal section when the second thread engages with the first thread; and
a nut screwed with the third thread to fasten the retention bolt to the external flange such that the head is restrained from sliding on the external flange along the slot.

2. A hydraulic filter securing device comprising:
a cover plate to be attached to a container of a hydraulic tank, the cover plate having a first opening;
an oil pipe provided through the first opening, the oil pipe having a first end attached to the cover plate and a second end opposite to the first end along a central axis of the oil pipe, the oil pipe including a first thread at the second end to engage with a second thread of a hexagonal section of a return filter;
an external flange provided on an outer side surface of the oil pipe between the first end and the second end along the central axis such that the external flange is apart from the container, the external flange having a bar insertion hole;
a retention bar comprising:
a head provided between the external flange and the first end along the central axis; and
a shaft passing through the bar insertion hole such that the shaft is contactable with the hexagonal section when the second thread is threaded into the first thread.

3. The hydraulic filter securing device according to claim 2,
wherein at least part of the shaft has a third thread,
wherein the bar insertion hole is a slot elongated in a circumferential direction with respect to the central axis,
wherein the head is provided on the external flange at a position along the slot such that the shaft is contactable with the hexagonal section when the second thread engages with the first thread, and
wherein the hydraulic filter securing device further comprises a nut screwed with the third thread to fasten the retention bar to the external flange such that the head is restrained from sliding on the external flange along the slot.

4. The hydraulic filter securing device according to claim 3,
wherein the external flange has a through-hole through which the oil pipe passes, a diameter of the through-hole being substantially equal to a diameter of the outer side surface of the oil pipe,
wherein the external flange has a first side and a second side opposite to the first side in a first side direction perpendicular to the central axis of the oil pipe, each of the first side and the second side having a substantially linear shape,
wherein the external flange has a third side and a fourth side opposite to the third side in a second side direction perpendicular to the first side direction and to the central axis of the oil pipe,
wherein the slot is provided between the through-hole and the third side in the second side direction, and
wherein a distance between the first side and the second side in the first side direction is substantially equal to a distance between two opposing sides of the hexagonal section.

5. The hydraulic filter securing device according to claim 4,
wherein the oil pipe comprises a protrusion protruded from the outer side surface of the oil pipe between the external flange and the second end along the central axis, and
wherein the diameter of the through-hole is smaller than a diameter of the protrusion.

6. The hydraulic filter securing device according to claim 5, further comprising a brazing filler material provided on the outer side surface of the oil pipe between the external flange and the protrusion along the central axis to connect the external flange and the protrusion.

7. The hydraulic filter securing device according to claim 6,
wherein the oil pipe comprises:
a first pipe portion comprising a pipe wall defining the outer side surface of the oil pipe and an internal hole surrounded by the pipe wall; and
a second pipe portion comprising:
a thread pipe portion having the first thread provided at the second end;
a threadless pipe portion inserted into the internal hole; and
a protruded pipe portion having the protrusion and provided between the thread pipe portion and the threadless pipe portion along the central axis of the oil pipe, and
wherein the hydraulic filter securing device further comprises a first bonding material bonding the first pipe portion to the second pipe portion.

8. The hydraulic filter securing device according to claim 7,
wherein the oil pipe further comprises a third pipe portion comprising:
a flange provided at the first end whose diameter is larger than a diameter of the first opening; and
an insertion hole into which the first pipe portion is inserted, and
wherein the hydraulic filter securing device further comprises a second bonding material bonding the first pipe portion to the third pipe portion.

9. A hydraulic tank assembly comprising:
the hydraulic filter securing device according to claim 1, further comprising a seal ring provided on the cover plate such that the seal ring surrounds the first opening;
the return filter connected to the hydraulic filter securing device;
the hydraulic tank comprising the container having a second opening covered by the cover plate; and
a fastener configured to connect the cover plate to the container,
wherein the seal ring is provided between the cover plate and the container such that the second opening is surrounded by the seal ring.

10. The hydraulic tank assembly according to claim 9,
wherein the container has a shape of a truncated triangular prism,
wherein the container has a first side wall and a second side wall opposite to the first side wall, each of the first side wall and the second side wall having a shape of a truncated triangle having a first substantially untruncated corner, a second substantially untruncated corner, and a truncated corner,
wherein the container has a top wall, a front wall, a slanted bottom wall, and a rear wall, each connecting the first side wall and the second side wall,
wherein the top wall is provided between the first substantially untruncated corner and the second substantially untruncated corner and has the second opening,
wherein the front wall is provided between the first substantially untruncated corner and the truncated corner and is supported by a mudguard of a work vehicle,
wherein the rear wall is provided between the second substantially untruncated corner and the truncated corner,
wherein the slanted bottom wall is provided at the truncated corner to connect the rear wall and the front wall, and
wherein the slanted bottom wall is opposite to the second opening in a vertical direction substantially perpendicular to the top wall.

11. The hydraulic tank assembly according to claim 10,
wherein the oil pipe extends in the vertical direction.

12. The hydraulic tank assembly according to claim 11,
wherein a bottom end of the return filter is provided between the slanted bottom wall and the front wall in a lateral direction perpendicular to the vertical direction.

13. The hydraulic tank assembly according to claim 10,
wherein the cover plate has a vent hole inside the seal ring.

14. The hydraulic tank assembly according to claim 13, further comprising:
a vent pipe connected to the vent hole;
an air breather connected to the vent pipe; and
an outlet tube connected to the air breather.

15. The hydraulic tank assembly according to claim 10, further comprising:
an oil supply port provided on the top wall; and
a cap to close the oil supply port.

16. The hydraulic tank assembly according to claim 10, further comprising:
a drain pipe provided on the slanted bottom wall.

17. The hydraulic tank assembly according to claim 10, further comprising:
a delivery pipe provided adjacent to the slanted bottom wall and connected to a hydraulic pump of the work vehicle.

18. A work vehicle comprising the hydraulic filter securing device according to claim 1.

19. A work vehicle comprising the hydraulic filter securing device according to claim 2.

20. A work vehicle comprising the hydraulic tank assembly according to claim 9.
